(19) United States
(12) Patent Application Publication
(10) Pub. No.: US 2005/0218050 A1
(43) Pub. Date: Oct. 6, 2005

(54) Flushable water changing base and multi-tasking caps

(76) Inventor: CHRISTOPHER CHOI, NEW BERLIN, WI (US)

Correspondence Address: CHRISTOPHER CHOI, 14800 W. DAKOTA ST., NEW BERLIN, WI, 53151, US

(21) Appl. No.: 10/708,976

(22) Filed: Apr. 5, 2004

(51) Int. Cl. A01K 63/04

(52) U.S. Cl. 210/169

(57) ABSTRACT

This system can be divided into three sections. The stand section consists of a stand 1 that has enough clearance to not interfere with the invention. The upper section can consist of all or some of the components pointed out as tank liner 3 and aquarium tank walls 2. The lower section is the focus of my invention that consists of bottom tank piece 4, support pads 5, coarse main medium 6, fine main medium 7, coarse center medium 8, fine center medium 9, main plug seal 10, slide rod 11, water change cap 14, and water change rod 15. Bottom tank piece 4 attaches to the bottom of the upper section and inside the clearance cutout of the stand section. The bottom tank piece 4 has sloping walls to guide waste to a center orifice in the bottom tank piece 4. Support pads 5 are needed as structural pieces to spread out the load to various places along the bottom tank piece 4. The coarse main medium 6 is placed on top of the bottom tank piece 4 and/or support pads. The coarse main medium 6 is rigid and has larger mesh orifices than the fine main medium 7. The mediums prevent the gravel from falling in to the lower section of the aquarium system, and only allows smaller particles to get through. The slide rod 11 gets assembled to the main plug seal 10 and that unit gets inserted into the center orifice. The water change cap 14 can be screwed up and fitted to the center orifice in the bottom tank piece 4, as shown in FIGS. 1 and 3. Once the water change cap 14 is attached, the water change rod gets inserted into the slide rod 11 as shown in FIG. 8 . Water change rod 15 is pushed up to open the main plug seal 10 or lowered to close the main plug seal 10. After flushing the water out, a water tap or a pail with suitable water can be used to refill the top aquatic section.

### BACKGROUND OF INVENTION

1. Background—Field of Invention

This invention relates to a tropical fish hobby, specifically in an area focusing on water change for maintaining the aquarium.

2. Background—Discussion of Prior art

Originally tanks were designed to work with filters to maintain the aquarium. Over the years as the tropical hobby started advancing, so did the fish and the various filters. There are submersible filters, canister filters, hanging filters, wet/dry filters, bed filters, and under-gravel filters. For some hobbyist, a tank and a filter(s) combination will work fine. For the advanced hobbyist, they will face the following issues:

1. They typically will have fancy fish that requires high level of maintenance.

2. They will have a very large size tanks that makes maintenance difficult.

3. They will have very fancy landscaping that makes it very difficult to do any kind of cleaning.

Filters do an effective job of filtering out particles, but at some point the hobbyist has to do a water change. In fact single most important advice for aquarists, by many experts in the field, is frequent water changes. Depending on the fish, tank, and filter some have to change the water every other day. Here is how most hobbyist conduct their water change:

1. Remove the canopy and the light.

2. Take out ornaments. The more ornaments removed will allow easier access to the bottom of the aquarium.

3. Siphon out water from the bottom of the tank, which is where most of the waste is accumulated.

4. Rinse the ornaments that were pulled out.

5. Put the ornaments back in the tank.

6. Replenish the tank with fresh water.

This is a very long and tedious process, especially if the tank is large and has landscaping. The process also stresses the fish, which can lead to disease and death.

Over the history, inventors created several cleaning systems to improve the cleaning and maintenance of the aquarium.

One of the first-known labor saving means for cleaning aquariums or keeping them clean is described in U.S. Pat. No. 649,494, issued to Sues on May 15, 1900. At a bottom dihedral of a V-shaped aquarium, it has a discharge tube with inlet orifices on top of the tube for receiving waste from the aquarium. However, food mixed with the waste on a layer of sand bridging between opposite sides at the bottom and on an edge of the tube. There, fish seeking food were relied on to agitate the waste and the food to make the waste fall into the discharge tube. The fish were obliged to select food from among their feces and much of it along with the feces and other waste went into the tube. It was an attempt at keeping an aquarium clean but actually did more harm than good. It was not successful.

The most successful known means for keeping an aquarium clean was described in U.S. Pat. No. 3,638,616, issued to Carmouche on Feb. 1, 1972. Its practicality was limited, however, to commercial fish farming with aquariums to compete with commercial fish ponds for producing fish for food on a large scale. The Carmouche patent claimed a composite of items and features that make practice of the invention very impractical and in some ways undesirable for ornamental aquatic culture. Eliminating some and changing other features of the Carmouche device as taught and claimed was essential for most aquatic culture not related to producing fish for food commercially. It had a large waste section with a separate slanted filter protruding from a single slated wall to partially clean waste in the waste section to accommodate high density of fish. It did not teach nor provide an adequate flushing rate of removal of water in the waste section. It relied solely on continuous supply of water from a tap, instead of optional periodic replacement of water with other means. Making it unusable in a building, on a floor or on a rug, it incorporated an overflow tank that limited it to use outside on the ground where water from the overflow tank could run onto the ground. A ball valve to which it was limited for outlet-valve control was not efficient in use of liquid mass of water above it for assuring valve sealing when not flushing. With air bubbles on a side to cause water circulation, it caused fish to seek the air bubbles from only half as much of the volume of water as from a central positioning of aeration air bubbles.

It did not maximize flushing because the orifice was down-sized as the fluid passed through the valve.

U.S. Pat. No. 3,785,342 is an integrated under gravel filter for an aquarium. The filter does not have a collection chamber that you find in an under-tank type of base. It has complicated plumbing and a side drain that is not as effective as a center drain for flushing.

U.S. Pat. No. 4,612,876 does not have a collection chamber. It does not maximize the flushing because the orifice is down sized as the fluid passes through the valve.

U.S. Pat. No. 4,807,565 is too complicated and it doesn't work with any off-the-shelf tanks and stands.

U.S. Pat. No. 4,995,980 discloses an arrangement for biological purification of water where the water within a tank is separated into a space above and a space below a partition. The partition consists of sand or gravel sandwiched between two screens. A diffuser aerates and agitates the water in the space above the partition. The water below the partition has low oxygen content and has above it a layer supersaturated in oxygen occupied by micro algae and aerobic microorganisms.

U.S. Pat. No. 5,269,914 is an undergravel filter and it does not enable draining though the bottom.

U.S. Pat. No. 5,640,930 is a flushing device consisting of main tank section and the waste section. Although it is a flushing system there are some flaws and limitations:

1. The aeration system is located just below a mesh screen. This does not maximize circulation for area below the air source.

2. The system does not have an option for a secondary seal, in case the first seal leaks.

3. Maintenance of the valve and the air supply line, located below the perforated medium, is difficult because there isn't a good way to seal in the liquid.

4. The flushing action is not optimized for the given exhaust orifice of the waste-collecting base. The design is activated by the turning of a valve, which is slow and ineffective until fully open. Even when fully opened, you cannot get the effective passage as big as the exhaust orifice of the waste-collecting base. The effective passage will be necked down, due to the valve. The flow rate is controlled by the effective orifice of the valve, and not by the size of the inlet orifice of the waste-collecting base. Therefore, the flush is not optimized for the given exhaust orifice of the waste-collecting base.

5. Their air circulating method is too complicated and difficult to maintain if the pores of the aeration pipe is to be plugged. The entire content of the tank must be removed to service the aeration pipe.

U.S. Pat. No. 5,690,054 discloses an aquarium system consisting of a tank with flanges which support an under gravel filter with side inlet holes and a cleanout. The floor of the tank is shaped to provide one or more depressed areas into which waste is directed by gravity and water flow and from which a drain system allows the waste and stale water to be removed without the need for vacuuming. A filter tower extends upward from the filter and returns filtered water into the tank. This invention is very similar to the U.S. Pat. No. 5,640,930 mentioned above and shares the similar flaws.

U.S. Pat. No. 6,234,113 B1 is a filtration system, not a water change system.

1. Again it uses the rotating valve, which does not maximize flushing.

2. The proposed waste-collecting base has to be big, rigid, and able to support the complete weight of the tank and its contents. This adds to cost and weight of the waste-collecting base.

3. This patent does not provide for aeration at the base.

In U.S. Pat. No. 6,533,928, water does not drain through the bottom of the tank.

Other known aquarium-cleaning devices employing a bottom waste section screened from a top fish section of an aquarium have had slower flushing with confined flow and less flushing effect with horizontal bottoms of the bottom waste sections. Included have been U.S. Pat. No. 5,179,911, issued to Chow, et al. on Jan. 19, 1993; U.S. Pat. No. 4,957,623, issued to Henzlik on Sep. 18, 1990; U.S. Pat. No. 4,944,248, issued to Torng on Jul. 31, 1990; U.S. Pat. No. 4,817,561, issued to Byrne, et al. on Apr. 4, 1989; U.S. Pat. No. 3,854,450, issued to Puckett on Dec. 17, 1974; and British P published Application Number 2,032,792, filed by Shawcross on Sep. 19, 1979. These horizontal-bottom and slow-flow types of cleaning devices have not been widely accepted.

### SUMMARY OF INVENTION

It is an object of the present invention to at least minimize the disadvantages referred to above. This invention will alleviate the tedious task of the water change. Other objects and advantages are:

(a) With a simple change be able to give additional seal to prevent leaking in the event primary seal fails. This acts as a fail-safe mode. This backup seal is important for maintenance of the base assembly. E.g. If the main seals wear out, how would the valve be replaced? If a rock or gravel got stuck in the main valve how would it be removed? This backup system is required to do any kind of maintenance on the base assembly.

(b) With a simple change be able to flush out the water.

(c) With a simple change be able to aerate from the lowest area of the tank.

(d) With a simple change be able to recycle the water.

(e) With a simple change be able to recycle and aerate from the lowest area of the tank.

(f) The aquarium system may be integrally formed with a tank and from the base of a tank. Alternatively, the invention can be retrofitted to an existing tank by completely, or partially, removing the original base.

(g) True Flush design that will generate the largest suction force for a given entry cross-section of the exhaust feature in the waste-collecting base. In other words, my invention does not go through a valve that can take away the cross section needed for the maximum flush for the given opening in the waste-collecting base.

(h) The gravel side of the medium will be flat so the hobbyist can maximize the usable surface area for decoration.

(i) If in the event this invention goes into mass production and is made from plastic, the tooling cost will be minimized due to only one main parting line. All the base features can be captured with the top and bottom core and cavity.

(j) We have an air bubble initiated circulation system for the under tank portion of the tank. This is important for growth of “good bacteria” in the base chamber. Not having any kind of circulation promotes growth of harmful microorganisms that creates odor, discoloration of the water, and disease.

(k) We also have a water initiated circulation system that can get recycled though a filter.

(l) My invention offers an option for different sized grid patterns. This gives flexibility in allowing the hobbyist to choose the various styles of gravel.

(m) Main location of the exhaust outlet is in the lowest area of the base and centered about the base.

(n) The multi-layer design makes replacing a layer simple and inexpensive.

(o) The initial exhaust feature will point down to maximize flow.

(p) All moving parts can be removed or replaced without having to empty out the liquid in the tank.

(q) Our exhaust path in the flushing mode is bend free, and allows the biggest opening possible for that given flow path. The effective orifice is also the entrance orifice, thus creating one of the better suction forces induced by gravity.

(r) My invention can be made to fit any size tank.

(s) My invention can be made to fit any shape tank.

(t) My feet features of the base allows support for more heavier loads for a given material, size, and thickness of the boundary medium versus other designs where the boundary medium is only supported around the outer perimeter.

(u) The shallow design of the base allows for lesser amount of water that needs to be replaced.

(v) The amount of time needed to achieve fully open status in the exhaust path is very fast because the entry hole is not gradually opened like the rotating valve. Other designs are activated by the turning of a valve, which is slow and ineffective until fully open. Even if the rotating valve is fully open, passage is only as effective as the size of the inlet/outlet of the valve; so it is not fast as can be for a same size orifice. My design will flush with a maximum force for a given orifice induced by gravity alone.

(w) Maintenance on the air circulation system is very easy.

### BRIEF DESCRIPTION OF DRAWINGS

FIG. 1 is a quarter cutaway view of a tank assembly, in a water change configuration.

FIG. 2 is a top view of a tank assembly, in a water change configuration.

FIG. 3 is a front sectional cutaway view of a top view from FIG. 2, in a water change configuration.

FIG. 4 is isometric view of a base plate.

FIG. 5 is a front view of a base plate.

FIG. 6 is a top view of a base plate.

FIG. 7 is a side view of a base plate.

FIG. 8 shows components needed for a water change.

FIG. 9 shows a piece needed for additional seal.

FIG. 10 shows components needed for aeration.

FIG. 11 shows component needed for water re-circulation.

FIG. 12 shows components needed for aeration and water re-circulation.

FIG. 13 shows top view of multiple base plates to show how a base plate can be used in series, or any other arrangement, for a lager tank. Base plate does not need to be connected side by side. View is shown this way as an example.

FIG. 14 shows side view of multiple base plates to show how a base plate can be used in series, or any other arrangement, for a lager tank. Base plate does not need to be connected side by side. View is shown this way as an example.

### LIST OF REFERENCE NUMERALS

1 stand
2 aquarium tank walls
3 tank liner
4 bottom tank piece
5 support pad
6 coarse main medium
7 fine main medium
8 coarse center medium
9 fine center medium
10 main plug seal
11 slide rod
12 airstone
13 second seal cap
14 water change cap
15 water change rod
16 air bubble cap
17 water recycle cap
18 air and water recycle cap

### DETAILED DESCRIPTION

Description of Invention-Preferred Embodiment

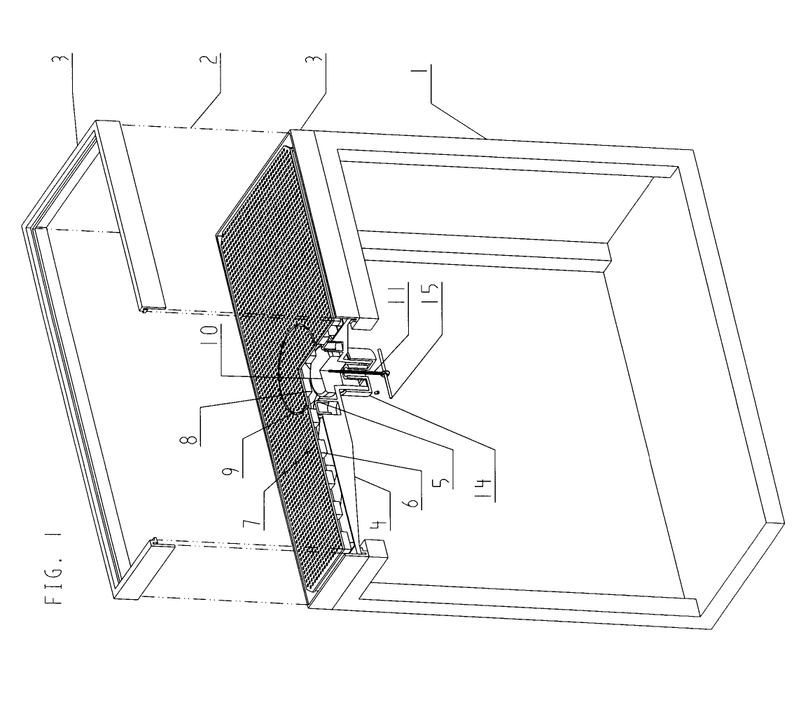

A preferred embodiment of the system is set up for water change and is illustrated in FIGS. 1, 2, 3, and 8. This system can be divided into three sections. The stand section consists of a stand 1 that has enough clearance to not interfere with the invention. The upper section can consist of all or some of the components pointed out as tank liner 3 and aquarium tank walls 2. The lower section is the focus of my invention that consists of bottom tank piece 4, support pads 5, coarse main medium 6, fine main medium 7, coarse center medium 8, fine center medium 9, main plug seal 10, slide rod 11, water change cap 14, and water change rod 15.

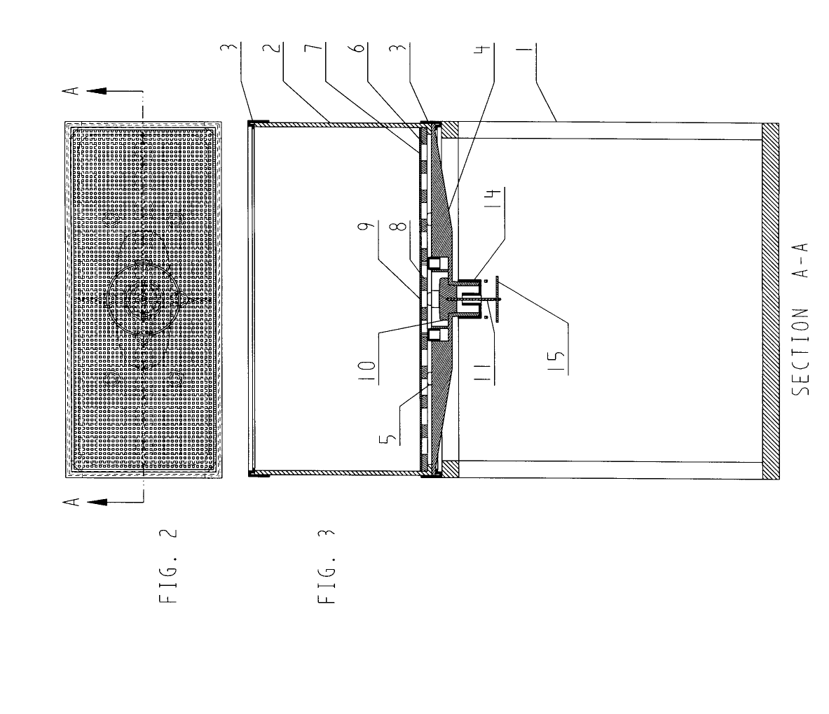

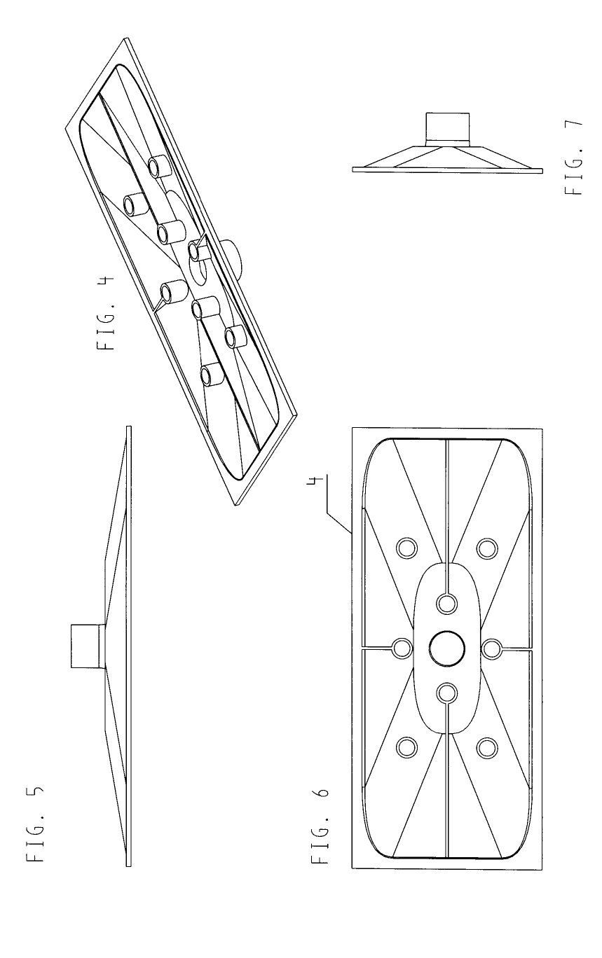

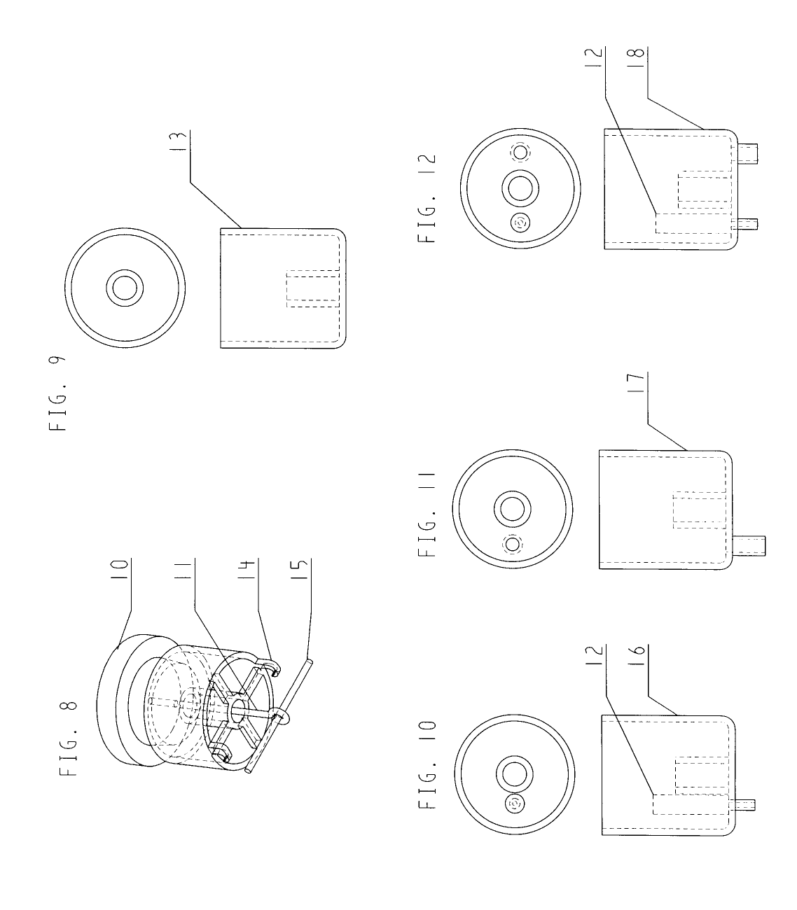

Bottom tank piece 4 attaches to the bottom of the upper section and inside the clearance cutout of the stand section. Note, if a person wants to retrofit my invention to a traditional flat bottom plate in the tank, the person can partially cut out a section in the bottom flat plate and have bottom tank piece 4 attach to the bottom of the partially cutout plate. The bottom tank piece 4 has sloping walls to guide waste to a center orifice in the bottom tank piece 4. FIGS. 4 to 6 illustrates the bottom tank piece 4 in detail. The various bosses around the center waste orifice are used to locate support pads 5. Support pads 5 are needed as structural pieces to distribute the load to various places along the bottom tank piece 4. The coarse main medium 6 is placed on top of the bottom tank piece 4 and/or support pads 5 and/or previous existing flat plate that had been cut out. The coarse main medium 6 is rigid and has larger mesh orifices than the fine main medium 7. The slide rod 11 gets assembled to the main plug seal 10 and that unit gets inserted into the center orifice. The coarse center medium 8 is then placed over the center orifice and on top of the support pads. The fine center medium 9 is then placed on top of the coarse center medium 8. The water change cap 14 and exhaust orifice of the bottom tank piece 4 will have a full or partial threaded features so the water change cap 14 can be screwed up and fitted to the center orifice in the bottom tank piece 4, as shown in FIGS. 1 and 3. Once the water change cap 14 is attached, the water change rod gets inserted into the slide rod 11 as shown in FIG. 8. Water change rod 15 can be pushed up to open the main plug seal 10 or lowered to close the main plug seal 10.

Operation of Invention

Once the aquarium system has been set up, a user can treat the aquarium system like any other aquarium tank. To flush out the liquid from the aquarium system, attach water change cap 14 to the bottom of the bottom tank piece 4, ensuring slide rod 11 goes through the center hole of the water change cap 14. You then slide the water change rod 15 through the hole/loop in the slide rod 11. Place a bucket under the water change cap 14 and push up on water change rod 15 to let the liquid flow out. The user has the option of using the side holding features of the water change cap 14 to hold water change rod 15 in an up position. Once the desired amount of liquid has flowed out, the user can manipulate the water change rod 15 and force it down into close position to seal the waste orifice.

As an added security, a person can attach the secondary seal cap 13 to bottom of the bottom tank piece 4 as a second seal in the event the main plug seal 10 does not completely seal. Use the secondary seal cap 13 when servicing main plug seal 10 and slide rod 11.

If a person wants to create only air bubbles starting at the bottom of the aquarium system, attach air bubble unit FIG. 10 at the bottom of the bottom tank piece 4. Higher you attach the air bubble unit, the slide rod 11 will bottom out against the air bubble cap 16 which will cause the main plug seal to open up, thus allowing bubbles to get through.

Use the water recycle cap 17, if there is a need to connect the aquarium system to a sump unit, various filters, or need to connect to a hose to redirect the direction of the water flowing out of the orifice. Higher you attach the water recycle cap 17, the slide rod 11 will bottom out against the water recycle cap 17 which will cause the main plug seal to open up. Control the amount of liquid flow by controlling the upward location of the water recycle cap 17.

Use the air and water recycle unit FIG. 12, if there is a need to create bubbles starting at the bottom of the aquarium system, and if there is a need to connect the aquarium system to a sump unit, various filters, or need to connect to a hose to redirect the direction of the water flowing out of the orifice. Higher you attach the air and water recycle cap 18, the slide rod 11 will bottom out against the air and water recycle cap 18 which will cause the main plug seal to open up. Control the amount of liquid flow by controlling the upward location of the air and water recycle cap 18.

If a maintenance needs to be performed to the main plug seal 10, slide rod 11, or exhaust orifice of the bottom tank piece 4, attach the secondary seal cap 13, remove the fine center medium 9, remove the coarse center medium 8, proceed to removing the main plug seal 10 and the slide rod 11, and perform the maintenance required. This system allows minimum shuffling to the landscaping of the aquarium and best of all there is no need to drain the system.

Description and Operation of Alternative Embodiments

There are various possibilities to change the configuration of the invention to allow the invention to perform different tasks. Using one or combination of the following parts can change the function of the invention:

Airstone 12, second seal cap 13, water change cap 14, water change rod 15, air bubble cap 16, water recycle cap 17, air and water recycle cap 18.

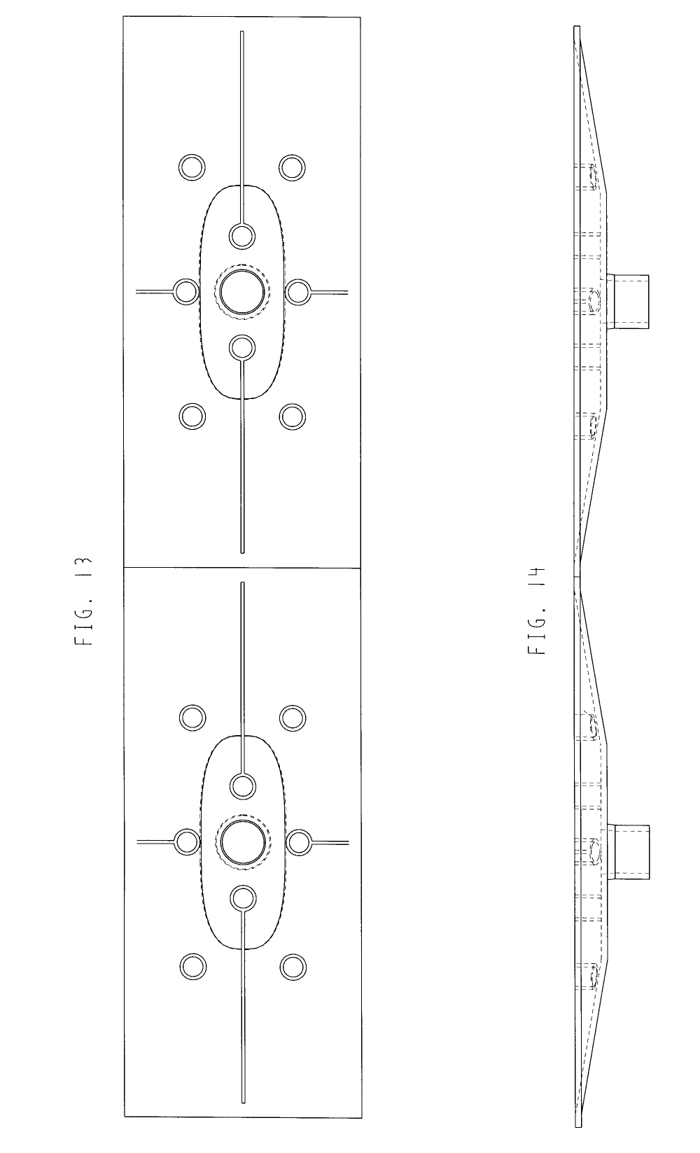

Depending on the type of operation for the aquarium maintenance, there are several choices of end attachments as shown in FIGS. 8 to 12. One of these attachments gets fitted to the bottom of the center orifice in the bottom tank piece 4. These end attachments along with the bottom tank piece 4 can be manufactured with one of several features that allow the attachment to be attached to the bottom of the bottom tank piece 4. Any kind of interlocking design can be used as long as it prevents fallout of the attachment and leaking at the interlocking feature. FIG. 8 shows the water change unit that consist of water change cap 14 and water change rod 15. FIG. 9 shows the secondary seal cap 13. FIG. 10 shows the air bubble unit consisting of air bubble cap 16 and airstone 12. The airstone will be connected to an air supply through a hose. FIG. 11 shows the water recycle cap 17. Recycle cap 17 allows the water to be passed through an orifice that can be connected to a sump unit, various filters, or can be connected to a hose to redirect the direction of the flow. FIG. 12 shows the air and water recycle unit that consists of air and water recycle cap 18 and the airstone 12. The system of FIGS. 13 and 14 operates in a very similar fashion to the system of FIGS. 1 to 3. FIGS. 13 and 14 is illustrating how the invention can be used in quantity of more than one, for a single aquarium tank system, as the tank sizes go up in sizes.

As an added security, a person can attach the secondary seal cap 13 to bottom of the bottom tank piece 4 as a second seal in the event the main plug seal 10 does not completely seal. Use the secondary seal cap 13 when servicing main plug seal 10 and slide rod 11.

If a person wants to create only air bubbles starting at the bottom of the aquarium system, attach air bubble unit FIG. 10 at the bottom of the bottom tank piece 4. Higher you attach the air bubble unit, the slide rod 11 will bottom out against the air bubble cap 16 which will cause the main plug seal to open up, thus allowing bubbles to get through.

Use the water recycle cap 17, if there is a need to connect the aquarium system to a sump unit, various filters, or need to connect to a hose to redirect the direction of the water flowing out of the orifice. Higher you attach the water recycle cap 17, the slide rod 11 will bottom out against the water recycle cap 17 which will cause the main plug seal to open up. Control the amount of liquid flow by controlling the upward location of the water recycle cap 17.

Use the air and water recycle unit FIG. 12, if there is a need to create bubbles starting at the bottom of the aquarium system, and if there is a need to connect the aquarium system to a sump unit, various filters, or need to connect to a hose to redirect the direction of the water flowing out of the orifice. Higher you attach the air and water recycle cap 18, the slide rod 11 will bottom out against the air and water recycle cap 18 which will cause the main plug seal to open up. Control the amount of liquid flow by controlling the upward location of the air and water recycle cap 18.

If a maintenance needs to be performed to the main plug seal 10, slide rod 11, or exhaust orifice of the bottom tank piece 4, attach the secondary seal cap 13, remove the fine center medium 9, remove the coarse center medium 8, proceed to removing the main plug seal 10 and the slide rod 11, and perform the maintenance required. This system allows minimum shuffling to the landscaping of the aquarium and best of all there is no need to drain the system.

The bottom tank piece 4 doesn't have to be a one-piece part. It can be made up of several components and parts to function as the bottom tank piece 4.

In the bottom tank piece 4, the surface that mates up to the walls of the tank can be any shape. For example, if the upper section of the aquarium system is curvy, domed, or any shape other than square or a rectangle, the bottom tank piece 4 will reflect the change in the mating profile and reflect that profile on the mating surface of the bottom tank piece 4.

Any or all of the following components can be removed if a user decides to use an undergravel filter in combination with the invention: Fine main medium 7, fine center medium 9, coarse main medium 6, and coarse center medium 8.

Any or all of the following components can be removed if a user decides not to landscape the aquarium and wants to use the aquarium system for strictly water changing purpose: Fine main medium 7, fine center medium 9, coarse main medium 6, and coarse center medium 8.

The exhaust ports on the bottom tank piece 4, water recycle cap 17, and air and water recycle cap 18 can be of different shape and size, depending on the size of a tank, exhaust flow requirements, and various fittings that the user might want to attach it to.

FIG. 13 shows top view of multiple base plates to show how a base plate can be used in series, or any other arrangement, for a lager tank. Base plate does not have to be connected side by side. View is shown this way as an example.

FIG. 14 shows side view of multiple base plates to show how a base plate can be used in series, or any other arrangement, for a lager tank. Base plate does not need to be connected side by side. View is shown this way as an example.

The support pads 5 can be set up in various quantity and arrangement to add and spread out the weight it is supporting.

My invention can be sold as a complete aquarium system that includes the upper section, lower section, and the base. Or the lower base section can be sold and the customer would make the aquarium system.

Conclusions, Ramifications, and Scope of Invention

Thus the reader will see that the flush tank and the multi tasking caps of the invention provide an excellent way to maintain an aquarium. It allows for the maximum flush induced by gravity, and allows for the largest opening without having to neck down through a valve. Pieces can be sold separately allowing user to put together the flushing aquarium system, and the interchangeable caps are so versatile in providing multiple features necessary for the aquarium hobbyist.

While my above description contains many specificities, these should not be construed as limitations on the scope of the invention, but rather as an exemplification of one preferred embodiment thereof. Many other variations are possible. For example:
Any kind of material can be used as long as the material property allows the parts to function as intended.
There can be many more cap designs that are able to attach to the exhaust orifice on the bottom tank piece 4. As long as the function of the cap deals with moving or agitating the liquid immediately above it, the feature can be captured in a cap and attach to the exhaust orifice
With more advanced shapes of aquarium tanks, the bottom tank piece 4 can take on the different shape on the top mating surface to reflect the shape of the bottom shape of the aquarium tank, whether it be curvy, circular, rectangle, or any other closed shape.

Accordingly, the scope of the invention should be determined not by the embodiments(s) illustrated, but by the appended claims and their legal equivalents.

1. Flushing base for draining liquid, comprising:
(a) a bottom waste section of rigid material of sufficient size and volume which funnel downward from flat top to a flushing orifice;
(b) a screening means for providing porous barrier between upper main liquid chamber and lower waste section chamber;
(c) a plugging seal that can be manipulated to open and close the flushing orifice at beginning of an entrance of the orifice;
whereby said location of the plugging seal at the beginning of an entrance of the orifice allows for a maximum flow for a predetermined cross section at the entrance point;
whereby said location of the plugging seal at the beginning of an entrance of the orifice does not interfere with the cross section throughout a liquid flow path from the entrance point to a discharge point.

2. The flushing base as described in claim 1 and further comprising:
various attachments of different functions to be attached at the discharge point of the discharge orifice.

3. The flushing base as described in claim 2 wherein said attachment is a water-change cap for flushing out the liquid.

4. The flushing base as described in claim 2 wherein said attachment is a secondary seal cap for adding addition seal to the discharge point.

5. The flushing base as described in claim 2 wherein said attachment is an air-bubble cap to generate air bubbles for circulation and oxygenation at a lowest point of the orifice.

6. The flushing base as described in claim 2 wherein said attachment is a liquid recycle cap that has a smaller orifice for connection to various style connectors.

7. The flushing base as described in claim 2 wherein said attachment is an air-liquid-recycle cap to generate air bubbles and to provide smaller orifice for making connection to various style connectors.

8. A flushing base as described in claim 1 wherein:
the bottom waste section can have plurality of receiving features to allow supporting pads to be mounted and adjusted for height.

9. The flushing base as described in claim 8 wherein said supporting pads get screwed into the receiving features at various heights whereby said supporting pads will help in spreading out the weight to various areas on the bottom waste section.

10. The flushing base as described in claim 1 and further comprising:
a liquid holding tank having an appropriate cutout undersurface for joining to the top surface of the bottom waste section.

11. The flushing base as described in claim 1 and further comprising:
an aquarium stand having a plurality of designedly vertical walls; and tops of the designedly vertical walls of the aquarium stand being attachable to bottoms of the designedly vertical walls of the aquarium proximate a position of attachment of the designedly coned walls of the bottom waste section to the designedly vertical walls of the aquarium.

12. The flushing base as described in claim 1 and further comprising:
a removable center screen for servicing the flushing base.

13. The flushing base as described in claim 1 wherein:
(a) the screening means is a net having mesh orifices sized and shaped to prevent passage of desired aquatic life and desired articles in the aquarium while allowing passage of feces and waste products related to culture of the desired aquatic life;
(b)the net is positioned on a grate that is rigid;
(c)the grate is oriented horizontally and extended between the vertical walls of the aquarium at a position proximate a joinder of tops of the walls of the bottom waste section and the top aquatic section, such that the screening means forms a bottom of the aquarium that separates the top aquatic section from the bottom waste section.

14. The flushing base as described in claim 1 wherein:
the plugging seal is in close position when the plugging seal is pulled down;
the plugging seal is in open position when the plugging seal is pushed up.

15. The flushing base as described in claim 14 wherein:
the plugging seal has an attachment feature to receive a sliding rod.

16. The flushing base as described in claim 15 wherein:
The sliding rod is attached to said plugging seal on one end and it has a female receiving feature on the other end for capturing a leverage bar.

17. The flushing base as described in claim 16 wherein:
The said leverage bar goes through the said sliding rod to act as a lever to open and close the said plugging seal.

18. The flushing base as described in claim 17 wherein:
The said water change cap has sleeve feature for the said sliding rod to move up and down;
The said water change cap has capturing features that allow said leverage bar to be held in open position.
